(19) United States
(12) Patent Application Publication
(10) Pub. No.: US 2024/0160753 A1
(43) Pub. Date: May 16, 2024

(54) METHOD FOR PROTECTING SENSITIVE DATA IN A THREAT DETECTION NETWORK AND THREAT DETECTION NETWORK

(71) Applicant: WithSecure Corporation, HELSINKI (FI)

(72) Inventors: Jarno NIEMELÄ, Helsinki (FI); Neeraj SINGH, HELSINKI (FI); Antti PIETARINEN, HELSINKI (FI)

(21) Appl. No.: 18/503,347

(22) Filed: Nov. 7, 2023

(30) Foreign Application Priority Data
Nov. 10, 2022 (GB) 2216750.6

(51) Int. Cl. G06F 21/60; H04L 9/14; H04L 9/40

(52) U.S. Cl. CPC G06F 21/602; H04L 9/14; H04L 63/1416

(57) ABSTRACT

A threat detection network, an endpoint of a threat detection network, a server of a threat detection network and a method for protecting sensitive data in a threat detection network, which threat detection network includes at least one end point, at least one server and an encryption key storage, such as a key server. In the method the endpoint generates a data encryption key to be used for encrypting sensitive data and the endpoint sends the encryption key to the encryption key storage. When the endpoint records an event, it checks the event related information for identifying sensitive data. The endpoint uses the encryption key to encrypt the event related information identified as sensitive data. The endpoint sends at least part of the event related information with encrypted sensitive data to the at least one server.

### TECHNICAL FIELD

The present invention relates to a threat detection network, an endpoint of a threat detection network, a server of a threat detection network and a method for protecting sensitive data in a threat detection network.

### BACKGROUND

Security and threat detection systems for computers and computer networks are used to detect threats and anomalies in computers and networks. Examples of such are Endpoint Protection Platform (EPP), Endpoint Detection & Response (EDR) and Managed Detection and Response (MDR) products and services. An endpoint protection platform (EPP) is a solution deployed on endpoint devices to prevent file-based malware attacks, detect malicious activity, and provide the investigation and remediation capabilities needed to respond to dynamic security incidents and alerts. Also, EDR systems focus on the detection and monitoring of a breach as it occurs and helps to determine how best to respond the detected breach. MDR in turn is a managed cybersecurity service providing service for threat detection, response, and remediation. The growth of efficient and robust threat detection solutions has been made possible in part by the emergence of machine learning, big data and cloud computing.

EPP, EDR or other corresponding systems deploy data collectors, such as agents or sensors, on selected network endpoints, which can be any elements of IT infrastructure. The data collectors observe activities happening at the endpoint and then send the collected data to a central, backend system, often located in the cloud. When the backend receives data, the data can be processed (e.g. aggregated and enriched) before being analyzed and scanned by the security system provider for signs of security breaches and anomalies.

One of challenge of the prior art systems is that there is often information in the organizations which must not be able to leave the organization in a format that can be read by any external party. This also includes the cyber security vendor, e.g. MDR/EDR vendor. The information can be for example in file names or in file content, internal URL names, etc. If the sensitive information would be removed from the collected data before it is being sent by the sensor, the missing data can cause problems, e.g. in case if there is a need to investigate for example which confidential files have been accessed by the attacker. In such case this information would not be available for investigation if sensitive data would have been removed from the sent data. And if the sensitive data is not removed from the collected data, then sensitive information is shared with external parties.

Thus, there is a need to achieve a reliable threat detection system which is also able to protect sensible data collected from the endpoints or other sources.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

According to a first aspect, the invention relates to a method, e.g. a computer implemented method, for protecting sensitive data in a threat detection network, which threat detection network comprises at least one end point, at least one server and a means for storing encryption keys, such as a key server. In the method the endpoint generates a data encryption key to be used for encrypting sensitive data and the endpoint sends the encryption key to the means for storing encryption keys. When the endpoint records an event, it checks the event related information for identifying sensitive data and uses the encryption key to encrypt the event related information identified as sensitive data. The endpoint sends at least part of the event related information with encrypted sensitive data to the at least one server.

In one embodiment of the invention the at least one endpoint collects threat detection related data from the endpoint by a security agent module installed at the endpoint.

In one embodiment of the invention based on an identified or determined security incident the data decryption key for sensitive data is retrieved from the means for storing encryption keys for the affected endpoints for the affected time period and at least part of the sensitive data is decrypted with the retrieved encryption key.

In one embodiment of the invention the means for storing encryption keys is arranged in the network in which threat detection related data is collected or to a separate network and/or a separate organization in which case the encryption keys will be stored in encrypted format for example into a blockchain, IOTA tangle, Hashgraph, or other distributed ledger.

In one embodiment of the invention the encryption keys are generated and/or stored inside a secure hardware module such as USB device or an HSM module.

In one embodiment of the invention the encryption key is a symmetric or a public/private key pair.

In one embodiment of the invention the new encryption key is generated periodically, e.g. daily or hourly, and the endpoint uses the currently active encryption key to encrypt the event related information that is identified as sensitive data.

In one embodiment of the invention the sensitive data is identified by keyword matching, by regular expressions, reading pre-defined content classification fields from document or other files and/or querying file confidentiality status from a content classification system.

In one embodiment of the invention the at least one endpoint and/or a user of the at least one endpoint uploads the relevant decryption keys to a service which has collected detection related data.

According to a second aspect, the invention relates to an endpoint of a threat detection network, the network comprising at least one endpoint and at least one server. The endpoint comprises at least one or more processors and at least one security agent module which is configured to collect data related to the respective network node, and the endpoint is configured to generate a data encryption key to be used for encrypting sensitive data and the endpoint is configured to send the encryption key to a means for storing encryption keys. When the endpoint records an event, it is configured to check the event related information for identifying sensitive data, and to encrypt the event related information identified as sensitive data with the encryption key. The endpoint is configured to send at least part of the event related information with encrypted sensitive data to the at least one server.

According to a third aspect, the invention relates to a server, e.g. a key server, of a threat detection network, the threat detection network comprising endpoints and at least one server. The server comprises at least one or more processors and is configured to receive and store data encryption keys generated by endpoints and used by the endpoints for encrypting sensitive data, and to provide the data encryption key for the selected endpoints for a defined time period.

According to a fourth aspect, the invention relates to a threat detection network comprising at least one endpoint according to invention and/or at least server according to the invention, such as a key server.

In one embodiment of the invention the threat detection network is configured to carry out a method according to any embodiment of the invention.

According to a fifth aspect, the invention relates to a computer program comprising instructions which, when executed by a computer, cause the computer to carry out a method according to the invention.

According to a sixth aspect, the invention relates to a computer-readable medium comprising the computer program according to the invention.

With the solution of the invention, it's possible to prevent the sensitive data to leave an organization or network in a directly readable format and at the same time to maintain this sensitive data in case it is needed in some cases, e.g. when an an incident needs to be investigated. With the solution of the invention this can also be done in a efficient and reliable manner.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE DRAWINGS

The embodiments of the invention are illustrated by way of example, and not by way of limitation, in the figures of the accompanying drawings.

FIG. 1 presents schematically an example network architecture of one embodiment of the invention.

FIG. 2 presents schematically an example network architecture of one embodiment of the invention.

FIG. 3 presents an example method according to one embodiment of the invention.

### DETAILED DESCRIPTION

A threat detection network according to one embodiment of the invention may comprise at least one endpoint and a backend system comprising at least one backend server. In this case information, e.g. threat detection related data, can be shared between the endpoints and/or between the endpoints and the backend system.

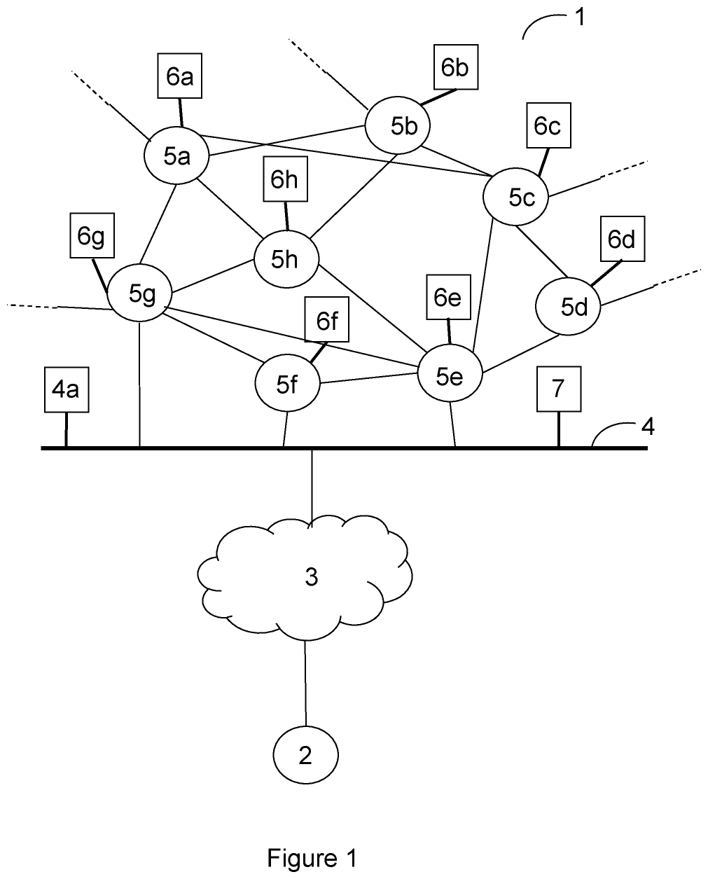

FIG. 1 presents schematically an example network architecture of one embodiment of the invention in which the solution of the invention can be used. In FIG. 1 a part of a first computer network 1 is schematically illustrated into which a computer system, for example an EPP or an EDR system, has been installed. Also, any other computer system that is able to implement the embodiments of the invention can be used instead or in addition to the EPP or EDR system used in this example. The first computer network is connected to a security service network, in one embodiment a security backend system or server 2, through the cloud 3. The backend system or server 2 forms a node on the security service computer network relative to the first computer network. The security service computer network can be managed by a threat detection system provider and may be separated from the cloud 3 by a gateway or other interface (not shown) or other network elements appropriate for the backend 2. The first computer network 1 may also be separated from the cloud 3 by a gateway 4 or other interface. Other network structures are also possible.

The first computer network 1 is formed of a plurality of interconnected network nodes 5a-5h, each representing an element in the computer network 1 such as a computer, smartphone, tablet, laptop, or other piece of network enabled hardware. In one embodiment of the invention the node is any device on the network but not a gateway. Each network node 5a-5h shown in the computer network can also represent an endpoint, e.g. an EDR endpoint or EPP endpoint, onto which a security agent module 6a-6h, that may include a data collector or sensor, is installed. Security agent modules may also be installed in some embodiments of the invention on any other element of the computer network, such as on the gateway or other interface. In the example of FIG. 1 a security agent module 4a has been installed on the gateway 4. The security agent modules, 6a-6h, 4a collect various types of data at the nodes 5a-5h or gateway 4 including, for example, program or file hashes, files stored at the nodes 5a-5h, logs of network traffic, process logs, binaries or files carved from memory (e.g. DLL, EXE, or memory forensics artefacts), and/or logs from monitoring actions executed by programs or scripts running on the nodes 5a-5h or gateway 4 (e.g. tcp dumps). The data collected may be stored in a database or similar model for information storage for further use and/or sent to for further analysis. Any kind of threat detection models may further be constructed at the backend/server 2, and/or at a second server and be stored in the database. The nodes 5a-5h and the server 2 typically comprise a hard drive, a processor, and RAM.

Any type of data which can assist in detecting and monitoring a security threat, such as a security breach or intrusion into the system, may be collected by the security agent modules 6a-6h, 4a during their lifecycle and that the types of data which are observed and collected may be set according to rules defined by the threat detection system provider upon installation of the threat detection system and/or when distributing components of a threat detection model and/or a behavior model. In an embodiment, a suspicious or malicious event among the monitored events may be detected by one or more detection mechanisms used. In an embodiment, the detection mechanisms used to detect the suspicious or malicious event may comprise using (in addition to machine learning models) a scanning engine, a heuristic rule, a statistical anomaly detection, fuzzy logic-based models, any predetermined rules.

In an embodiment of the present invention, at least part of the security agent modules 6a-6h may also have capabilities to make decisions on the types of data observed and collected themselves. For example, the security agents 6a-6h, 4a may collect data about the behavior of programs running on an endpoint and can observe when new programs are started. Where suitable resources are available, the collected data may be stored permanently or temporarily by the security agent modules 6a-6h, 4a at their respective network nodes or at a suitable storage location on the first computer network 1 and/or sent further.

The security agent modules 6a-6h, 4a are set up such that they send information such as the data they have collected or send and receive instructions to/from the threat detection system backend 2 through the cloud 3. This allows the threat detection system provider to remotely manage the system without having to maintain a constant human presence at the organization which administers the first computer network 1.

In one embodiment of the invention, the security agent modules 6a-6h, 4a can also be configured to establish an internal network, e.g. an internal swarm intelligence network, that comprises the security agent modules of the plurality of interconnected network nodes 5a-5h of the local computer network 1. As the security agent modules 6a-6h, 4a collect data related to the respective network nodes 5a-5h of each security agent module 6a-6h, 4a, they are further configured to share information that is based on the collected data in the established internal network. In one embodiment a swarm intelligence network is comprised of multiple semi-independent security nodes (security agent modules) which are capable of functioning on their own as well. Thus, the numbers of instances in a swarm intelligence network may well vary. There may also be more than one connected swarm intelligence networks in one local computer network, which collaborate with one another.

The security agent modules 6a-6h, 4a and/or the backend system can be further configured to use the collected data and information received from the internal network for generating and adapting models related to the respective network node 5a-5h and/or its users. Models can be for example threat detection models and/or consistency models.

The collected data may comprise sensitive information such as names of persons or other personal information. In the solution of the invention parts of the collected data which comprise sensitive information are identified and encrypted so that they are not shared externally as plaintext. In the solution of the invention an infrastructure can be created for generating and storing time-based encryption keys for encrypting sensitive data that are unique per an endpoint or a sensor of the endpoint and for a certain time period. These keys for encrypting sensitive data can be used to scramble any event data, collected e.g. by an agent at the endpoint, which contains sensitive information, and if an incident needs to be investigated, the correct decryption key for encrypting sensitive data can be used to access a plain text version of given endpoint's or sensor's sensitive data for given time period. This minimizes the exposure of sensitive information even in investigation case.

In one example embodiment a key server can be set up at the user organization (where the data is collected) for storing the keys for encrypting sensitive data. In the example embodiment of FIG. 1, the key server 7 is arranged this way to the network 1 of the user organization.

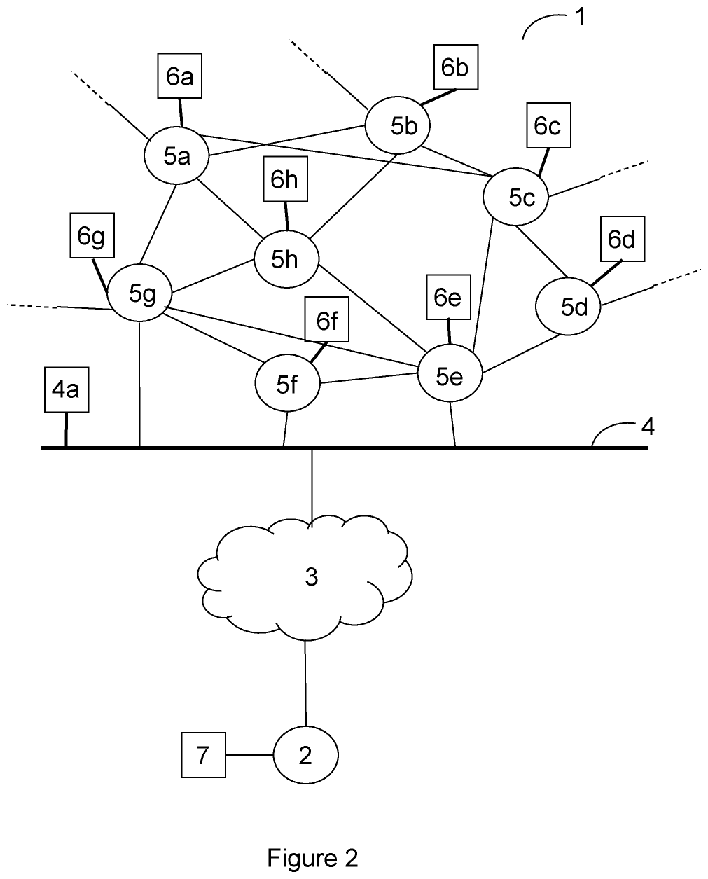

In one embodiment the key server is maintained by an external organization, e.g. by security service provider, and protected by additional encryption key that is in control of the user organization. This kind of solution is presented in FIG. 2, which presents otherwise similar solution as FIG. 1 but the key server for sensitive data in FIG. 2 is arranged to the backend 2 of the security service provider.

In one embodiment the keys for encrypting sensitive data can be stored in encrypted format into a blockchain, IOTA tangle, Hashgraph, or other distributed ledger. In one embodiment the keys for encrypting sensitive data can be generated and stored inside secure hardware module such as an HSM module that would for example be installed on every computer protected by EDR in the organization. In these cases a key server may not be needed.

The agent or sensor of the endpoint can generate a sensitive data encryption key. The key can be a symmetric key or public/private key pair. New encryption key can be generated periodically, for example daily or hourly, depending on the needs of the organization. The agent or sensor of the endpoint can send the encryption key for encrypting sensitive data to the means for storing the encryption keys, e.g. to the key server or other secure key storage, such as hardware security module or block chain. In one embodiment of the invention the sensor or agent can also store the generated encryption keys to the endpoint and/or home network in addition to the means to store the encryption keys.

The user organization can create configuration for identifying sensitive data so that sensitive data can be identified from the event data to be stored. Identifying sensitive data can be e.g. carried out by keyword matching, finding regular expressions, reading pre-defined content classification fields from document or other files and/or querying file confidentiality status from content classification system of the organization.

In one embodiment, the configurations for identifying the sensitive data can be locked so that an endpoint can't edit or alter the criteria how the sensitive data is identified. In one embodiment of the invention the configurations for identifying sensitive data are signed when distributed to the sensors or agents and on-host modifications are rejected.

When a sensor records an event, it will check the event fields against sensitive data based on the identified parts of the event related information. Any part of the event data that matches sensitive information will be encrypted with the currently active encryption key.

In one embodiment of the invention data which comprises encrypted sensitive information can be marked so that at decrypting phase it is known which parts have to be decrypted. In one embodiment of the invention the shared and/or stored data can comprise an identifier for the key with which the sensitive data was encrypted.

In case of an incident, the user organization can retrieve the sensitive data decryption key for the sensitive data from key storage, e.g. for the affected sensors for the affected time period. In one embodiment of the invention the user organization can upload the relevant decryption keys for the sensitive data to security provider's service user interface, e.g. a dashboard or other user interface, which for that allows viewing detections or alert related data. If forensic investigation is performed, the organization can hand the relevant decryption keys to the forensic investigator who can decrypt also the sensitive the data. This way the original information can be seen which can help to solve and analyse the incident.

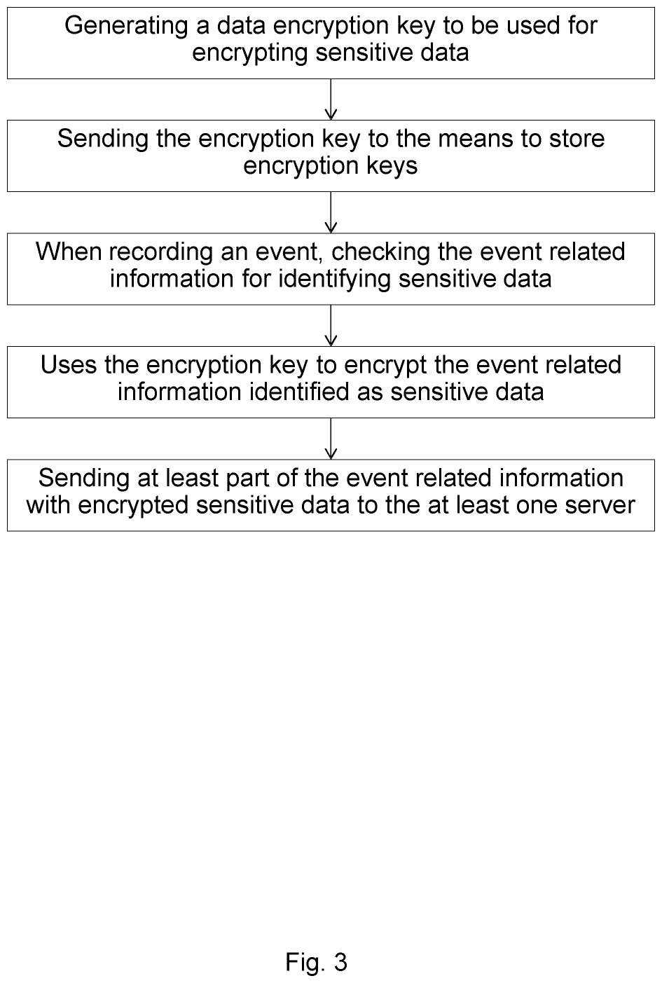

FIG. 3 presents an example method according to one embodiment of the invention. In the example method the endpoint generates a data encryption key to be used for encrypting sensitive data. The endpoint sends the encryption key to the means for storing encryption keys. When the endpoint records an event, it checks the event related information for identifying sensitive data. The endpoint uses the encryption key to encrypt the event related information identified as sensitive data. In the method the endpoint sends at least part of the event related information with encrypted sensitive data to the at least one server.

In one embodiment of the invention the data which is not identified as sensitive is not encrypted with the data encryption key for sensitive data and/or not with same encryption key as the data identified as sensitive data. In one embodiment of the invention the sensitive data can be separately encrypted from the other data used or sent in the solution of the invention. In one embodiment of the invention the sensitive data can be encrypted with the data encryption key for sensitive data before all transferred data is encrypted with another encryption key before the data is sent via the network.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. Lists and groups of examples provided in the description given above are not exhaustive unless otherwise explicitly stated.

1. A method for protecting sensitive data in a threat detection network, which threat detection network includes at least one end point, at least one server and a means for storing encryption keys, wherein in the method:
the endpoint generates a data encryption key to be used for encrypting sensitive data,
the endpoint sends the encryption key to the means for storing encryption keys,
when the endpoint records an event, the endpoint checks the event related information for identifying sensitive data,
the endpoint uses the encryption key to encrypt the event related information identified as sensitive data,
the endpoint sends at least part of the event related information with encrypted sensitive data to the at least one server.

2. The method according to claim 1, wherein the at least one endpoint collects threat detection related data from the endpoint by a security agent module installed at the endpoint.

3. The method according to claim 1, wherein based on an identified or determined security incident the data decryption key for sensitive data is retrieved from the means for storing encryption keys for the affected endpoints for the affected time period and at least part of the sensitive data is decrypted with the retrieved encryption key.

4. The method according to claim 1, wherein the means for storing encryption keys is arranged in the network in which threat detection related data is collected or to a separate network and/or a separate organization in which case the encryption keys will be stored in encrypted format.

5. The method according to claim 1, wherein the encryption keys are generated and/or stored inside a secure hardware module.

6. The method according to claim 1, wherein the encryption key is a symmetric or a public/private key pair.

7. The method according to claim 1, wherein the new encryption key is generated periodically, and the endpoint uses the currently active encryption key to encrypt the event related information that is identified as sensitive data.

8. The method according to claim 1, wherein the sensitive data is identified by keyword matching, by regular expressions, reading pre-defined content classification fields from document or other files and/or querying file confidentiality status from a content classification system.

9. The method according to claim 1, wherein the at least one endpoint and/or a user of the at least one endpoint uploads the relevant decryption keys to a service which has collected detection related data.

10. An endpoint of a threat detection network, the network including at least one endpoint and at least one server, wherein
the endpoint includes at least one or more processors and at least one security agent module which is configured to collect data related to the respective network node, and
the endpoint is configured to generate a data encryption key to be used for encrypting sensitive data,
the endpoint is configured to send the encryption key to a means for storing encryption keys,
when the endpoint records an event, the endpoint is configured to check the event related information for identifying sensitive data, and to encrypt the event related information identified as sensitive data with the encryption key, and
the endpoint is configured to send at least part of the event related information with encrypted sensitive data to the at least one server.

11. A server of a threat detection network, the threat detection network including endpoints and at least one server, wherein
the server includes at least one or more processors and is configured to
receive and store data encryption keys generated by endpoints and used by the endpoints for encrypting sensitive data, and
provide the data encryption key for the selected endpoints for a defined time period.

12. A threat detection network including:
at least one endpoint according to claim 10, and/or
at least one server.

13. A threat detection network wherein the threat detection network is configured to carry out a method according to claim 2.

14. (canceled)

15. A computer-readable medium on which is stored a computer program including instructions which, when executed by a computer, cause the computer to carry out the method according to claim 1.

16. The method according to claim 2, wherein based on an identified or determined security incident the data decryption key for sensitive data is retrieved from the means for storing encryption keys for the affected endpoints for the affected time period and at least part of the sensitive data is decrypted with the retrieved encryption key.

17. The method according to claim 16, wherein the means for storing encryption keys is arranged in the network in which threat detection related data is collected or to a separate network and/or a separate organization in which case the encryption keys will be stored in encrypted format.

18. The method according to claim 17, wherein the encryption keys are generated and/or stored inside a secure hardware module.

19. The method according to claim 18, wherein the encryption key is a symmetric or a public/private key pair.

20. The method according to claim 19, wherein the new encryption key is generated periodically, and the endpoint uses the currently active encryption key to encrypt the event related information that is identified as sensitive data.

21. The method according to claim 20, wherein the sensitive data is identified by keyword matching, by regular expressions, reading pre-defined content classification fields from document or other files and/or querying file confidentiality status from a content classification system.
